(19) United States
(12) Patent Application Publication
(10) Pub. No.: US 2026/0160659 A1
(43) Pub. Date: Jun. 11, 2026

(54) METHODS AND DEVICES FOR MEMS BASED GRAVIMETRIC PARTICULATE MATTER SENSORS

(71) Applicant: AHRAM MAANGEMENT AND CONSULTING INC., BROSSARD (CA)

(72) Inventors: ARASH DALILI SHOAEI, COQUITLAM (CA); MOHANNAD YOMN ELSAYED, SAINT LAMBERT (CA)

(21) Appl. No.: 19/409,949

(22) Filed: Dec. 5, 2025

Related U.S. Application Data
(60) Provisional application No. 63/728,810, filed on Dec. 6, 2024.

(51) Int. Cl. G01N 15/06

(52) U.S. Cl. CPC G01N 15/0606

(57) ABSTRACT

Gravimetric particulate monitoring sensors provide direct mass measurement unlike optical sensors that estimate particle concentration indirectly. A micro-gravimetric sensor measures the actual mass of particulate matter without assumptions of the particulates being measured such as color, how they reflect light etc. The gravimetric approach offers consistent accuracy across different types of particulate matter where devices are taught exploiting inertial forces for particle deposition, heater integration within a MEMS resonator based mass sensor for thermophoretic particle removal, and an advanced measurement algorithm for enhanced measurement accuracy over a wide range of particle sizes and types.

### CROSS-REFERENCE TO RELATED APPLICATIONS

This patent application claims the benefit of priority from U.S. Provisional Patent Application 63/728,810 filed Dec. 6, 2024; the entire contents of which are incorporated herein by reference.

### FIELD OF THE INVENTION

This patent application relates to microelectromechanical systems (MEMS) and more particularly to MEMS devices for particle detector sensors.

### BACKGROUND OF THE INVENTION

As a result of growing global concerns about the health impacts of air pollution, accurate and reliable air quality monitoring has become important in order to support environmental management and environmental control but also for protecting public health. Particulate matter, a major air pollutant, has been linked to a range of serious health problems, including respiratory disorders, cardiovascular diseases, and exacerbated lung conditions where international bodies such as the World Health Organization as well as national or state (provincial) regulations etc. define the number of particles of different sizes, such as those less than 100 μm, 10 μm and 2.5 μm (4 micro-inch, 0.4 micro-inch, 0.1 micro-inch) that can be present within air in different environments. These being commonly referred to as Ambient Air Quality (AAQ) standards or guidelines according to the issuing party.

Accordingly, effective air quality monitoring allows for the timely implementation of pollution control measures and health advisories, thereby mitigating the adverse effects of polluted air on communities etc. as well as allowing compliance to be verified and air pollution control measures to be assessed quantitatively.

Amongst particulate sensors known in the art gravimetric sensors are considered one of the most accurate methods for measuring particulate matter as these gravimetric sensors collect particles onto a filter which allows for the mass of the collected particles to be measured. Due to their accuracy, gravimetric sensors are often used as reference instruments in studies and for calibrating other types of PM sensors. The collection on a filter and subsequent weighing limiting their application to date in real time ongoing monitoring and assessment activities. In contrast, optical methods based upon light scattering have to date offered a more compact alternative with real time measurements albeit at the expense of the sensor's accuracy as several assumptions have to be made regarding material characteristics in order to estimate mass concentration.

Within U.S. Patent Application 2021/0123849 entitled “Methods and Devices for MEMS based Particulate Matter Sensors” the inventors introduced a particulate matter (PM) sensor that employs a sophisticated micro-gravimetric approach, marking a significant advancement over the traditional optical sensors typically found in compact air quality monitoring devices. The micro-gravimetric PM sensor utilizes a MEMS microbalance that can measure the increase in mass directly within the device thereby offering real-time gravimetric measurements and accordingly advantages over optical PM sensors. These advantages include, for example, direct mass measurement, tolerance to particle properties and longevity-stability.

Gravimetric PM sensors provide direct mass measurement unlike optical sensors that estimate particle concentration indirectly. A micro-gravimetric sensor measures the actual mass of particulate matter, providing a direct and accurate quantification of air pollution levels without assumptions of the particulates being measured. Similarly, a gravimetric sensor is unaffected by properties of the particulates whilst optical methods can be influenced by the physical characteristics of particles, such as their color or how well they reflect light etc. The gravimetric approach is impervious to such variations, offering consistent accuracy across different types of particulate matter. Similarly with respect to longevity and stability optical PM sensors require recalibration to maintain accuracy, especially in high-pollutant environments. In contrast, a micro-gravimetric sensor can be designed to operate with minimal maintenance, ensuring reliable performance and reduced operational costs over time. Within US 2021/0123849 thermophoresis was employed to periodically clean the gravimetric sensor element via an external “hot” plate below the mass-sensor where these terms are relative to ambient temperature and apply during the periods when the pair of thermophoretic plates are active during a “cleaning” or reset process of the PM sensor.

However, whilst US 2021/0123849 presented significant enhancements over prior art designs of PM sensors, it would be beneficial to provide PM sensors which enhance upon the prior art by exploiting inertial forces for particle deposition, integrate a heater within the MEMS resonator (mass sensor) for thermophoretic particle removal and exploit an advanced measurement algorithm for enhanced measurement accuracy over a wide range of particle sizes and types.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to particle detectors through the use of microelectromechanical systems (MEMS) resonators and more particularly to MEMS resonator devices for particle detector sensors.

In accordance with an embodiment of the invention there is provided a method of detecting particles comprising:
providing a sensor module comprising a microelectromechanical systems (MEMS) resonator and an electrode atop the MEMS resonator where the MEMS resonator is anchored by at least one anchor;
exposing the MEMS resonator to a flow of fluid comprising a plurality of particles; and
determining in dependence upon a shift in a characteristic of the MEMS resonator a mass of a portion of the particles deposited upon the MEMS resonator; wherein
the MEMS resonator is driven;
the flow of fluid is established by an output of a virtual impactor and a fan associated with the sensor module; and
the MEMS resonator includes a heater which is periodically actuated to clean another portion of the portion of the particles the particles deposited upon the MEMS resonator via thermophoresis to the fluid flowing past the MEMS resonator.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary configuration of a virtual impactor for directing particles of a known or desired size towards a sensor according to the prior art of US 2021/0123849;

FIG. 2 depicts a microelectromechanical systems (MEMS) resonator within the sensing region of a virtual impactor such as depicted in FIG. 1;

FIG. 3 depicts a MEMS resonator such as may be employed within the virtual impactor as depicted in FIG. 1;

FIG. 4 depicts a PM sensor module exploiting embodiments of the invention;

FIG. 5 depicts a cross-section of the PM sensor module of FIG. 3 exploiting embodiments of the invention;

FIGS. 6A and 6B depict schematics of virtual impactors according to embodiments of the invention outlining placement of MEMS sensor elements;

FIG. 7 depicts a cross-section of a PM mass sensor element according to an embodiment of the invention employing a piezoelectric-on-silicon resonator with integrated heater; and

FIG. 8 depicts a visual schematic of a calibration and operation process for a PM sensor according to an embodiment of the invention.

### DETAILED DESCRIPTION

The present description is directed to microelectromechanical systems (MEMS) resonators and more particularly to MEMS resonator devices for particle detector sensors.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

In order to address the requirements for a compact low cost particle detector and/particle sensor whether employed in monitoring particulates generally or specifically compliance etc. with PM regulations such as those defined by the WHO etc. as noted above it would be beneficial to provide an overall solution compatible with high volume fabrication processes in order to reduce the size and cost of PM detectors/sensors.

Accordingly, the inventors have established a novel particle detector/sensor which exploits a sensor based upon a piezoelectric resonator fabricated using a commercial multi-user MEMS process in conjunction with a micro virtual impactor to segregate the particles based upon their size and inertia imparted from an air flow through the particle detector/sensor. Accordingly, a flow of a known and desired size, e.g. PM2.5, can be separated and guided towards the sensing MEMS resonator. Further, the inventors have integrated in conjunction with the virtual impactor and MEMS resonator additional elements which exploit the principles of thermophoresis or di-electrophoresis to clear the particles from the sensing area of the MEMS resonator. This mechanism can force the particles towards and away from the sensing resonator based on a temperature or potential gradient. Accordingly, the MEMS resonator based particle detector/sensor can be periodically reset allowing for extended operational life of the MEMS resonator based particle detector/sensor and/or enhanced performance over extended periods.

The MEMS resonator established by the inventors employs piezoelectric transduction in the MEMS resonator employed as the sensing element as this offers several advantages compared to other transduction schemes, e.g. capacitive transducers. Specifically, it has higher electromechanical coupling, thus leading to lower impedance levels, and imposes less geometrical constraints on the release of the resonating membrane, since a lower electrode is not needed. Further, it does not require a large biasing voltage thereby simplifying the design of the interfacing electronics and facilitating its deployment in portable devices, e.g. particle detectors/sensors for personal health monitoring etc. However, it would be evident that other embodiments of the invention may use other MEMS resonator structures including other MEMS-based resonators (e.g., membrane resonators, beam resonators, etc.) exploiting other transduction techniques including, but not limited to, those employing capacitive based transduction.

The initial prototype particle detector/sensor employing a MEMS resonator in conjunction with the virtual impactor, fan etc. measures approximately 20 mm×20 mm×15 mm (approximately 0.8 inch×0.8 inch×0.6 inch) which the inventors believe is one of the smallest implementations of a self-contained particle detector/sensor reported to date. A limiting size factor for this particle detector sensor (PDS) according to an embodiment of the invention exploiting a MEMS sensor is the size of the fan integrated within the system to provide the air flow. Accordingly, a reduction of the footprint of the fan or its elimination from the PDS would provide for smaller footprints.

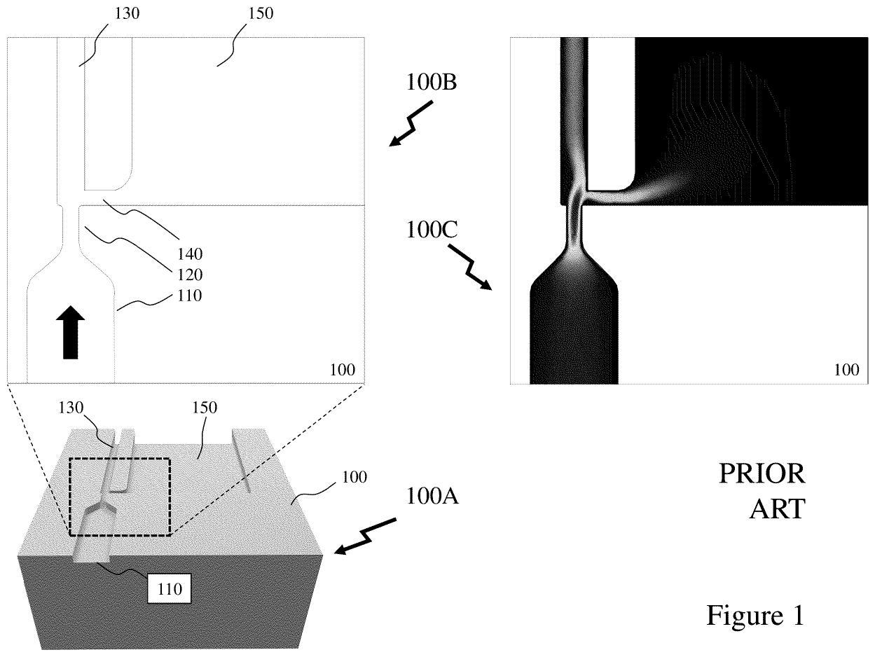

The concepts described and depicted below in respect of FIGS. 1 to 14 whilst being directed to a single MEMS resonator sensor within a sensing region which receives filtered particulates to meet PM 2.5 through the design of the virtual impactor may be configured for other discrete measurements, e.g. PM 10, or employed in series/parallel with other elements to perform multiple concurrent measurements.

Referring to FIG. 1 there is depicted a configuration of a virtual impactor for directing particles of a known or desired size towards a sensor within a particle detector sensor (PDS) according to US 2021/0123849. Referring to first image 100A there is depicted a three-dimensional schematic of a virtual impactor-sensor chamber (VISC) structure 100 according to an embodiment of the invention wherein an inlet port 110, outlet channel 130 and sensor chamber 150 are depicted formed within the surface of a substrate. Second image 100B depicts a plan view of the VISC structure 100 wherein there is depicted the inlet port 110 which receives an airflow from an ambient environment being monitored and/or sampled where this airflow may be generated by a fan either pushing air into the VISC structure 100 or pulling air into the VISC structure 100. This fan may be part of the PDS, e.g. within a discrete personal health monitoring device, or external to the PDS, e.g. a fan within an air conditioning system which the PDS is associated with.

As depicted the airflow within the inlet port 110 of the VISC structure 100 enters a restricted region 120 before entering a region comprising the outlet channel 130 and impactor arm 140. The impactor arm 140 coupling to a sensing chamber 150. Third image 100C depicts a computer simulation of the VISC structure 100 wherein the particle density is depicted. By appropriate design of the restricted region 120, outlet channel 130, and impactor arm 140 then particulates below a specific maximum particle size may be filtered selectively into the impactor arm 140 and therein to the sensor chamber 150.

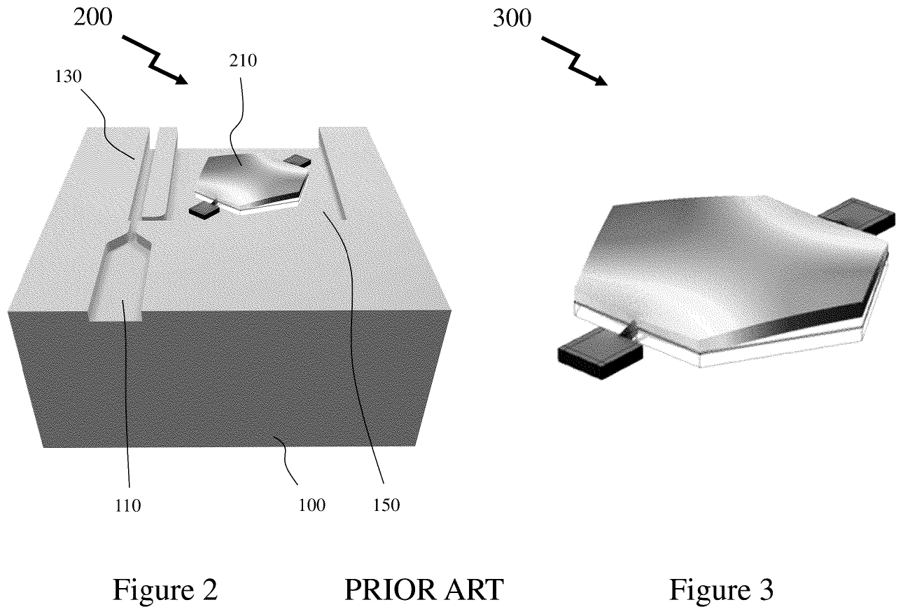

Now referring to FIG. 2 there is depicted a microelectromechanical systems (MEMS) resonator 210 within the sensing chamber (region) 150 of a virtual impactor-sensor chamber (VISC) structure 100 such as depicted in FIG. 1. As depicted the inlet port 110, outlet channel 130 and sensor chamber 150 are depicted formed within the surface of a substrate with the MEMS resonator 210 integrated within the sensor chamber 150. As will be described subsequently according to the selection of the substrate the MEMS resonator 210 may be monolithically integrated into the VISC structure 100 or it may be hybrid integrated into the VISC structure 100.

Referring to FIG. 3 there is depicted a MEMS resonator 300 such as may be employed for PDS according to embodiments of the invention such as may be employed within a VISC structure, such as VISC structure 100 as depicted in FIGS. 1 and 2 respectively. As described below the resonant frequency of the MEMS resonator 300 will reduce as particulates/particles deposit upon the upper surface of the MEMS resonator 300 loading it with a mass. This shift in the resonant frequency can be electrically measured through electrical scattering parameters (S-parameters) of an electrical circuit comprising the MEMS resonator 300 allowing the increased mass resulting from particulate/particle deposition to be determined/monitored. As depicted in FIG. 2 the MEMS resonator 210, for example MEMS resonator 300 in FIG. 3, is deployed within a sensor chamber 150 which receives via the VISC structure particles below a predetermined dimension determined by the design of the VISC structure.

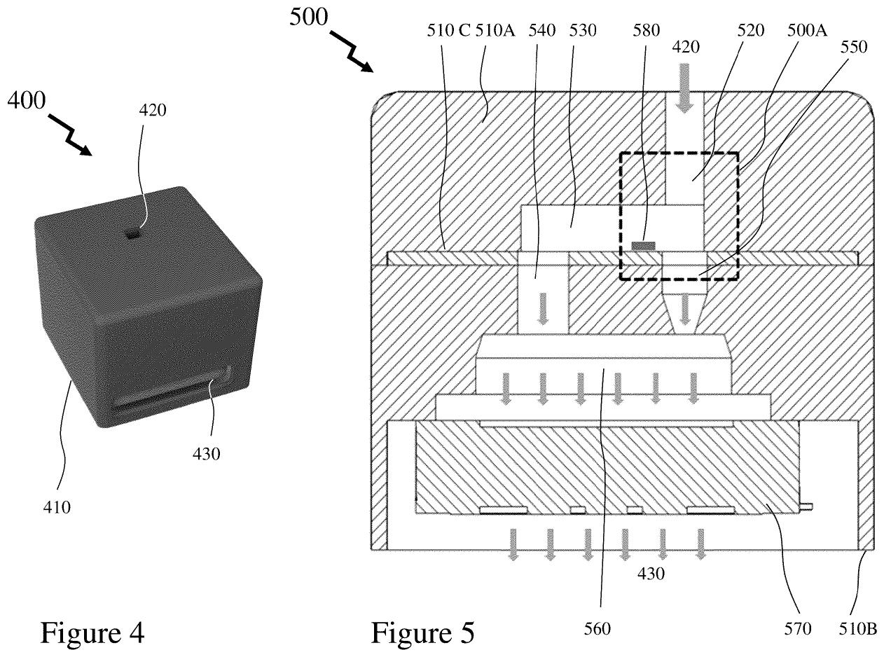

As noted above the inventors have established enhancements to the PM sensor described and depicted within US 2021/0123849 which are described herein with respect to FIGS. 4 to 8.

Referring to FIG. 4 there is depicts a PM sensor module (PM Module) 400 exploiting embodiments of the invention. PM Module 400 being designed to provide highly accurate and reliable measurements of air quality by detecting and quantifying the concentration of particulate matter in the air. This sophisticated sensor operates through a multi-step process that involves initial particle separation using a virtual impactor, direct particle deposition leveraging inertial forces, precise mass measurement with a microbalance resonator, and an advanced measurement algorithm to ensure ongoing accuracy.

The PM sensor according to embodiments of the invention is centered upon the separation of particles based on their aerodynamic size, achieved through the use of a virtual impactor. A virtual impactor leverages the principle of inertial forces to separate particles. When air containing particulate matter flows through the device, it encounters a sudden change in airflow direction. Particles with sufficient inertia, typically larger particles, cannot follow the sharp turn in the airflow and are diverted into a secondary stream, while smaller particles continue along the main airflow path. Accordingly, the PM Module 400 as depicted in FIG. 4 comprises a Body 410, an Input 420 and Outlet 430. Within FIG. 5 a cross-section of a PM Module 500 is depicted wherein rather than Outlet 430 being on the side (relative to defining the Inlet 410 as being on the top) the Outlet 430 is through the bottom surface of the PM 500.

As depicted PM Module 500 comprises Inlet 420 which couples to Inlet Channel 520 which then couples to Through Channel 550 and Side Channel 530. The intersection of these being designed according to the requirements of the Virtual Impactor 500A which incorporates Mass Sensor 580. The Side Channel 530 connects to Connecting Channel 540 wherein this and the Through Channel 550 are connected to Chamber 560 and therein to the Fan 570. The Fan 570 providing a defined air flow from the Inlet 420 to the Outlet 430 such that a first flow goes from Inlet Channel 520 to Through Channel 550 and the Chamber 560 whilst a second flow goes from the Inlet Channel 520 to Side Channel 530, Connecting Channel 540 and Chamber 560. Accordingly, particles smaller than a defined (predetermined) size, e.g. 2.5 μm, are separated by the Virtual Impactor 500A and traverse along the second flow whilst particles larger than the defined size traverse along the first flow.

The PM Module 500 comprising an Upper Body 510A, Lower Body 510B and Sensor Plate 510C. Within an embodiment of the invention the Sensor Plate 510C is a printed circuit board (PCB) which includes interfacing electronic circuits for Mass Sensor 580, e.g. MEMS resonator mass sensor, and the Mass Sensor 580 which is electrically connected to the PCB, e.g. wire-bonded onto the PCB. Within other embodiments of the invention, for example, a particle sensor within a high temperature environment the Sensor Plate 510 may be formed from a high temperature PCB material such as silicon or a ceramic such as alumina or aluminum nitride for example.

Within embodiments of the invention the Mass Sensor 580 may be formed as part of the Sensor Plate 510C, e.g. the Sensor Plate 510C is silicon or a ceramic for example. The Mass Sensor 580 may be silicon or a ceramic based sensor according to the temperature operating range of the PM Sensor 500 and/or the airflow or fluid flow through it.

Within embodiments of the invention the dimensions of the Virtual Impactor 500A may be established in dependence upon the pressure-flow operating point of the Fan 570 for the defined particle size limit below which particles are separated and measured with the Mass Sensor 580.

Within embodiments of the invention the Virtual Impactor 500A design may be fixed and the appropriate pressure-flow operating point of the Fan 570 established for the defined particle size limit below which particles are separated and measured with the Mass Sensor 580.

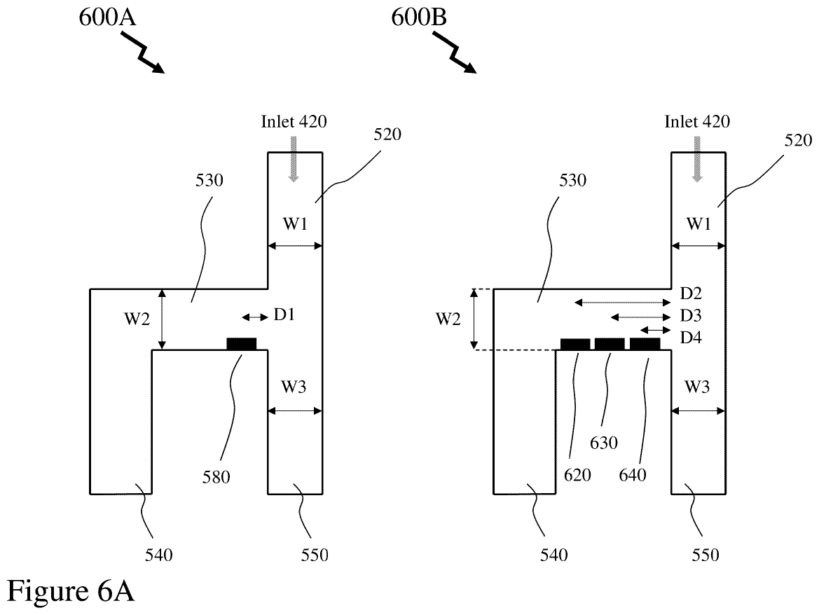

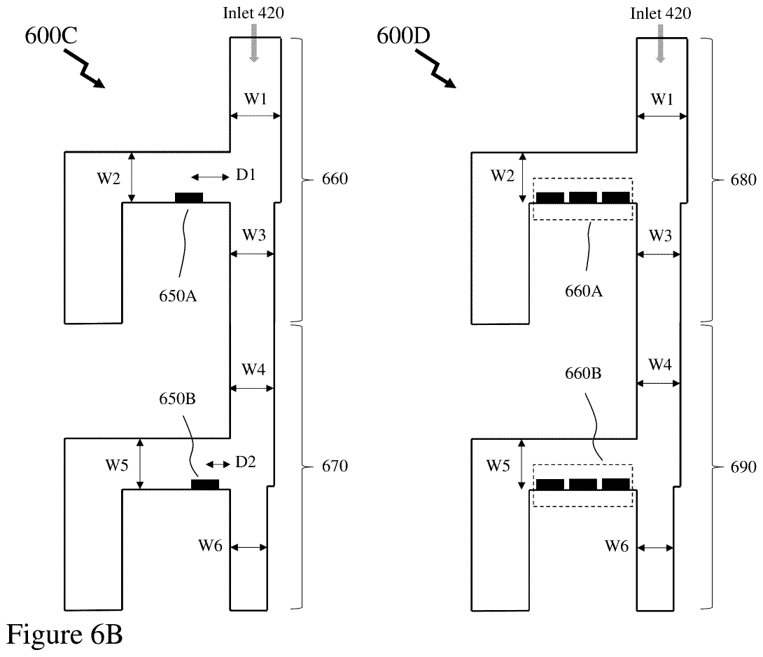

For example, referring to FIG. 6A there is depicted a first Schematic 600A of a virtual impactor such as Virtual Impactor 500A in FIG. 5 where the Mass Sensor 580 is positioned a distance D1 along the Side Channel 530 from the Inlet Channel 520 to Through Channel 550 path. For a defined flow-pressure combination, the dimensions of the channels (i.e., the width of the Inlet Channel 520 (W1), the width of the Through Channel 550 (W3), the width (strictly height) of the Side Channel 530 (W2), and the depths and lengths of the channels) are selected based on the target particle size. This initial segregation is important for enhancing the accuracy of subsequent measurements by ensuring that only particles within the desired size range proceed to the sensing chamber.

Within US 2021/0123849 “Methods and Devices for MEMS based Particulate Matter Sensors” by the inventors where thermophoresis was employed (through an external heater placed above the sensing element) to manipulate particles onto the sensing micro-resonator, embodiments of the invention position the Mass Sensor 580, for example a microelectromechanical systems (MEMS) resonator, perpendicular to the inlet airflow within the virtual impactor. This orientation leverages inertial forces to facilitate direct particle deposition onto the surface of the Mass Sensor 580, e.g. the MEMS resonator's surface. Based upon the air flow and geometry of the Virtual Impactor 500As or Schematic 600A larger particles cannot follow the abrupt change in airflow direction, depicted as 90° although other high angular offsets may be employed, and pass through whilst smaller particles can traverse the change in air flow direction and are deposited directly onto the surface of the Mass Sensor 580, e.g. MEMS resonator. By utilizing inertial forces for particle deposition, the requirement for an external manipulation mechanism such as thermophoresis during the deposition phase is eliminated. This reduces the complexity of the sensor design but also enhances measurement accuracy. The precise placement and orientation of the resonator ensure that particles of the desired size range effectively deposit on its surface, improving the efficiency and reliability of the sensor. As depicted in Schematic 600A the Mass Sensor 580 is disposed a distance D1 from the junction of the Side Channel 530 and Inlet Channel 520.

Referring to second Schematic 600B in FIG. 6 an alternative Virtual Impactor design is depicted wherein the Mass Sensor 580 in first Schematic 600A is replaced with first to third Mass Sensors 620 to 640 respectively at distances D2, D3 and D4 from the junction of the Side Channel 530 and Inlet Channel 520. For a fixed W2 the particle dimensions impacting each of the first to third Mass Sensors 620 to 640 respectively will vary allowing a distribution of particles to be established. Alternatively, the first to third Mass Sensors 620 to 640 respectively allow for a larger proportion of the particles flowing within the Side Channel 530 to impact the first to third Mass Sensors 620 to 640 respectively.

It would be evident that within embodiments of the invention the Virtual Impactor coupled to the Inlet 420 may one of several parallel Virtual Impactors such that particle counts for 2 or more particle size ranges may be established rather than employing multiple PM Modules 500.

Alternatively, referring to FIG. 6B in third and fourth Schematics 600C and 600D alternate cascaded designs are depicted. In third Schematic 600C a first Virtual Impactor 660 is coupled to the Inlet 420 with first PM Sensor 650A at a distance D1 and channels of widths W1, W2 and W3 whilst a second Virtual Impactor 670 with second PM Sensor 650B at a distance D2 and channels of widths W4, W5 and W6 is serially coupled to the first Virtual Impactor 660 where W4=W3 although within other embodiments of the invention W4≠W3.

In fourth Schematic 600D a first Virtual Impactor 680 is coupled to the Inlet 420 with first PM Sensor Array 660A and channels of widths W1, W2 and W3 whilst a second Virtual Impactor 690 with second PM Sensor Array 660B and channels of widths W4, W5 and W6 is serially coupled to the first Virtual Impactor 680 where W4=W3 although within other embodiments of the invention W4≠W3.

It would be evident that in other embodiments of the invention three or more Virtual Impactors may be serially connected.

Within an embodiment of the invention the PM Sensors such as PM Sensor 580 and first to third PM Sensors 620 to 640 in FIG. 6A, first and second PM Sensor 650A and 650B in FIG. 6B and PM Sensors within first and second PM Sensor Arrays 660A and 660B respectively a MEMS disk resonator may be employed such as described in US20210123849. However, within another embodiment of the invention another resonator type, e.g., MEMS beam resonator, may be employed. In either instance a microbalance resonator functions as a highly sensitive mass detector. As particles accumulate on the resonator's surface, its mass increases, causing a change in the natural frequency of the resonator. Specifically, the additional mass lowers the resonator's frequency, and this frequency shift is directly proportional to the amount of particulate matter collected and can be measured via an electrical circuit which can monitor the resonator's frequency in real-time, ensuring that changes in mass are detected with high resolution. This real-time monitoring capability allows for continuous and instantaneous measurements, making the sensor highly responsive and accurate. The high sensitivity of the microbalance resonator enables the detection of small changes in particulate matter concentration, providing precise and reliable air quality data.

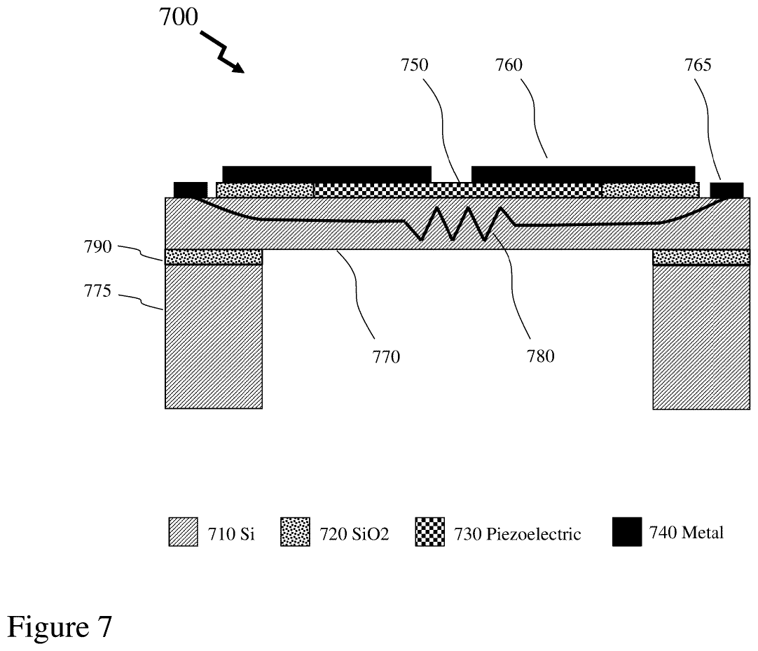

An exemplary MEMS beam resonator is depicted in cross-section in Schematic 700 in FIG. 7 comprising a Beam 790 formed from Silicon 710 which is suspended above an opening within the Substrate 775, Silicon 710, wherein the Beam 790 is isolated from the Substrate 775 by Insulator 790, Silicon Dioxide (SiO2) 720 for example. Disposed atop the Beam 790 is Piezoelectric Film 750 with first Contacts 760 whilst second Contacts 765 are directly upon the Beam 790. Accordingly, the Piezoelectric Film 750 under an applied electrical signal can establish the Beam 770 into an initial resonance wherein the addition of mass atop the PM sensor results in the resonant frequency shifting and the amplitude of the signal at the initial resonating frequency reducing and employed to track the addition of mass. Alternatively, the resonant frequency can be tracked by adjusting the applied electrical signal. Alternatively, measurements of the resonant frequency and response at other frequencies, e.g. initial resonant frequency, can be employed to determine the mass added to the beam.

Schematic 700 depicts a clamped-clamped beam resonator which is anchored at either end. Within another embodiment the resonator may be a clamped-free beam resonator, a disk resonator, a free-free resonator etc.

Within embodiments of the invention each PM Sensor such as PM Sensor 580 and first to third PM Sensors 620 to 640 in FIG. 6A, first and second PM Sensor 650A and 650B in FIG. 6B and PM Sensors within first and second PM Sensor Arrays 660A and 660B may be a single MEMS beam resonator or it may comprise multiple MEMS beam resonators in a defined configuration, e.g. adjacent to one another or across the width of the channel so that each MEMS beam resonator is at a common distance down the channel to the others. Alternatively, the multiple MEMS resonators may be disposed in a predetermined pattern.

In order to maintain the PM sensor's high accuracy and extend the lifespan of the microbalance resonator, a periodic cleaning mechanism utilizing thermophoresis is implemented through an integrated Heater 780 within the MEMS beam resonator as depicted in FIG. 7 in Schematic 700. By applying a controlled electrical current to second Contacts 765 current flows through the Beam 790 heating up thereby creating a temperature gradient between its surface and the surrounding cooler air (fluid) flowing past it. This temperature difference triggers thermophoresis, a phenomenon where particles naturally migrate from regions of higher temperature to regions of lower temperature due to differences in molecular collisions on the particle's surface. The accumulated particulate matter is thus propelled away from the hotter resonator surface and back into the airflow, effectively cleaning the sensor without the need for mechanical intervention.

Accordingly, by appropriate design of the Beam 790 and the electrical heating circuit a controlled temperature gradient on the resonator's surface can be established such that the PM Sensor efficiently leverages thermophoresis to remove particulate matter. This method ensures that the resonator remains clean, preserving the sensor's sensitivity and accuracy over time. The integrated heater design enhances energy efficiency by localizing heating, minimizing energy consumption compared to heating larger external components, and simplifies the sensor architecture by reducing the need for additional parts. As opposed to US20210123849A1, thermophoresis-based reset using an integrated microheater allows for a much faster reset due to the low thermal mass of the resonator, as opposed to the external heater used in US20210123849A1. It also enhances energy efficiency by localized heating and simplifies the sensor architecture by reducing the need for additional parts.

As depicted in FIG. 7 in prototype MEMS beam resonator PM sensors the integrated heater is implemented through the silicon device layer of the resonator's silicon-on-insulator structure. However, within other embodiments of the invention an additional resistive layer may be employed rather than the silicon of the beam, for example poly-silicon, a metal or alloy, for implementing the heater.

As depicted in FIG. 7 in prototype MEMS beam resonator PM sensors the resonator implementation utilizes a piezoelectric layer for electromechanical transduction. However, it would be evident that other actuation mechanisms such as capacitive may be employed.

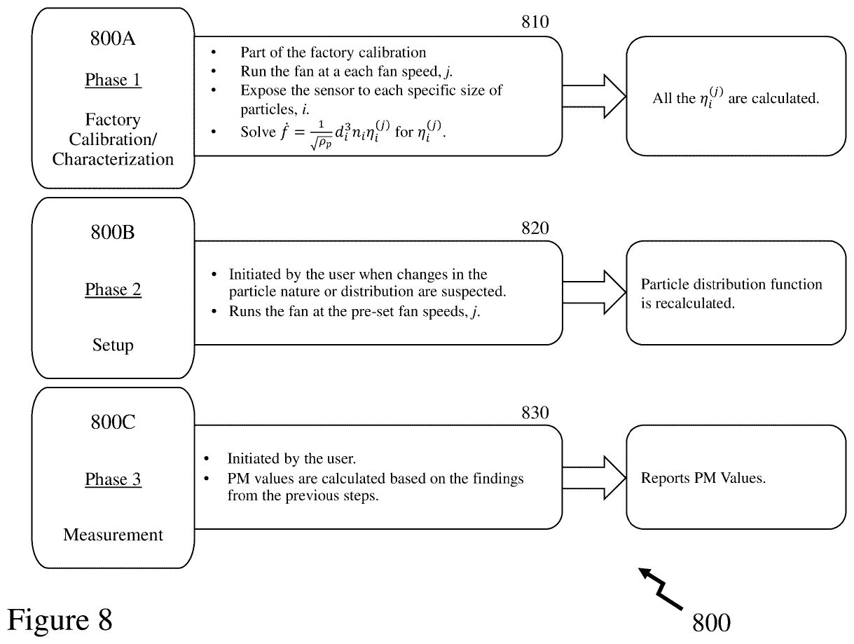

In order to further enhance the sensor's accuracy and reliability, the inventors have developed a novel calibration/measurement algorithm that operates in three primary phases as depicted in FIG. 8. This comprises three phases:
Phase 1 800A, Factory Calibration/Characterization;
Phase 2 800B, User Setup; and
Phase 3 800C, Measurement.

If we consider a PM Module such as PM Module 500 then in Phase 1 first Step 810 is executed wherein the fan associated with the PM Module, e.g. Fan 570, is run at a series of defined fan speeds, j, and the PM module exposed to particles of each specific size bin i, it is intended to measure. Accordingly, Equation (1) is then solved for

$${n}_{i}^{( j )}$$

where \dot{f} is the change in resonator frequency, dᵢ is the aerodynamic diameter of the particles, and

$${η}_{i}^{( j )}$$

is a unique efficiency factor for each size bin i, and fan speed j which indicates the fraction of particles that end up on the resonator. This phase is carried out during the factory calibration of the sensor and the purpose of this phase is to determine all the

$${η}_{i}^{( j )}$$

values in Equation (1). This is performed by subjecting the sensor to particles of specific sizes one by one, e.g., using a monodisperse aerosol generator, and operating the sensor using all the fan speeds one by one. This allows for calculation of the efficiencies

$$( {η}_{i}^{( j )} )$$

for all the fan speed/size bin combinations.

$$\dot{f} = \frac{1}{\sqrt{{ρ}_{p}}} {d}_{i}^{3} {n}_{i} {η}_{i}^{( j )} \qquad ( 1 )$$

In Phase 2 second Step 820 which is initiated by the user when changes in the particle nature or distribution of particles are suspected the PM Module re-executes running the fan at multiple fan speeds and the particle distribution is recalculated. It would be evident that within a PM Sensor which comprises multiple sensors, then within each Virtual Impactor and/or serially cascaded Virtual Impactor the particle distribution changes may be automatically detected. However, changes in particle type/nature may not be automatically detected unless additional sensors for such aspects of the particles are associated with the PM Sensor.

In Phase 3 third Step 830 which is also outlined as being initiated by the user then software is executed which calculates particulate mass (PM) values based upon the data from the PM Module.

Accordingly, this algorithm ensures the sensor maintains high precision across varying environmental conditions and particle distributions. The key to understanding how the PM sensor measures particulate matter lies in the relationship between the mass of particles deposited on the resonator and the corresponding change in its natural frequency. The resonator's frequency decreases as more mass is added, providing a direct method for calculating the amount of particulate matter present.

To define how particle deposition affects the sensor's readings, we begin by calculating the mass of the particles that accumulate on the resonator. It is assumed that the particulate matter spread over a wide range of sizes where the particle size distribution can be divided into a number of size bins (l). The formula for calculating the total mass of particles deposited on the resonator can be calculated as the sum of the accumulated mass for all the size bins and can be expressed as Equation (2) where n_{res,i} and V_{ave,i} are the number of particles that sit on the resonator and the average volume of the particles for a particular size bin i, and ρₚ is average density of the particles and where n_{res,i} is given by Equation (3) where n_{tot,i} is the total number of particles in size bin i that enter the sensor, and ηᵢ is the efficiency factor for bin i, indicating the fraction of particles that end up on the resonator.

$$m = {ρ}_{p} {\sum }_{i = 0}^{i = l} ( {V}_{ave , i} {n}_{res , i} ) \qquad ( 2 )$$

$${n}_{res , i} = {n}_{t o t , i} \times {η}_{i} \qquad ( 3 )$$

The total number of particles in a certain size bin i that enter the sensor, n_{tot,i}, is linearly related to the volumetric flow rate (Q) multiplied by the ambient particle concentration per unit volume for the same bin (nᵢ) over a certain period of time (t) as given by Equation (4). By combining Equations (2), (3) and (4) we obtain Equation (5).

$${n}_{tot , i} = Q \times {n}_{i} \times t \qquad ( 4 )$$

$$m = {ρ}_{p} {Q}_{t} {\sum }_{i = 0}^{i = 1} ( {V}_{ave , i} {n}_{i} {η}_{i} ) \qquad ( 5 )$$

As particles deposit on the resonator, their accumulated mass causes a measurable shift in the natural frequency (f) of the resonator. This frequency shift serves as the key indicator in determining the mass of particulate matter. The calibration process uses this relationship to translate the frequency changes into meaningful air quality data, giving real-time measurements of particulate matter concentration. As a result, the mass change of the resonator, which is the mass of particles sitting on it, is correlated with the change in frequency according to Equation (6).

$$\dot{m} ∝ \dot{f} \qquad ( 6 )$$

By differentiating Equation (5) with respect to time (t) it is possible to calculate the changes in the mass of particles on the resonator, which correlates with the concentration of particulate matter yielding Equation (7).

$$\dot{m} = {ρ}_{p} Q {\sum }_{i = 0}^{i = l} ( {V}_{ave , i} {n}_{i} {η}_{i} ) \qquad ( 7 )$$

$$\dot{f} = {αρ}_{p} Q {\sum }_{i = 0}^{i = 1} ( {V}_{ave , i} {n}_{i} {η}_{i} ) \qquad ( 8 )$$

By combining Equations (6) and (7) we obtain Equation (8) where α is a constant. To further refine the model, the average volume of particles in each size bin is calculated using the average aerodynamic diameter dᵢ as given by Equation (9) where dᵢ, d_{geo,i}, ρ_{w}, and χ are the aerodynamic diameter, geometrical diameter, density of water, and dynamic shape factor, respectively. The modified frequency change equation reflecting aerodynamic considerations is then given by Equation (10).

$${d}_{i} = {d}_{geo , i} \sqrt{\frac{{ρ}_{p}}{{ρ}_{w} χ}} \qquad ( 9 )$$

$$\dot{f} = \frac{απ Q \sqrt{{χ}^{3} {ρ}_{w}^{3}}}{6 \sqrt{{ρ}_{p}}} {\sum }_{i = 0}^{i = l} ( {d}_{i}^{3} {n}_{i} {η}_{i} ) \qquad ( 10 )$$

At each specific fan speed, denoted as j, a unique efficiency factor for each size bin i,

$${η}_{i}^{( j )} ,$$

is defined as given by Equation (11). This factor incorporates constants, the selected fan speed, and the size-specific deposition efficiency, adjusting the sensor's response based on operational conditions. The result is the formulation of a refined equation to accurately represent these dynamics in Equation (12).

$${η}_{i}^{( j )} = \frac{απ Q \sqrt{{χ}^{3} {ρ}_{w}^{3}}}{6} \qquad ( 11 )$$

$$\dot{f} = \frac{1}{\sqrt{{ρ}_{p}}} {\sum }_{i = 0}^{i = l} ( {d}_{i}^{3} {n}_{i} {η}_{i}^{( j )} ) \qquad ( 12 )$$

### Phase 1: Factory Calibration/Characterization.

This phase is carried out during the factory calibration of the sensor and the purpose of this phase is to determine all the

$${η}_{i}^{( j )}$$

values in Equation (12). This is performed by subjecting the sensor to particles of specific sizes one by one, e.g., using a monodisperse aerosol generator, and operating the sensor using all the fan speeds one by one. This allows for calculation of the efficiencies

$$( {η}_{i}^{( j )} )$$

at all the fan speed/size bin combinations.

In this detailed characterization process, the size spectrum of the particles is assumed to be divided into a certain number of size bins. The greater the number of bins, the more precise the calculation, but this also leads to increased complexity and time consumption during both characterization and sensor operation. Since particulate matter tends to follow a lognormal size distribution, we can calculate the particle distribution with only three bin sizes for example.

### Example Calculation:

For simplicity and illustration, we assume the entire spectrum from 0 to c μm is divided into three discrete bins: 0-a, a-b, and b-c. These bins are represented by a, b, and c, respectively. This segmentation allows for a more targeted analysis of particle behavior based on size, enhancing the precision of our measurements. Given this setup, the equation that describes the change in frequency (\dot{f}) due to particle deposition is revised to incorporate the contributions from each of the three size bins to the particle deposition on the sensor and can be expressed by Equation (13) where d is the aerodynamic diameter of the particles.

$$\dot{f} = \frac{1}{\sqrt{{ρ}_{p}}} ( {d}_{a}^{3} {n}_{a} {η}_{a}^{( j )} + {d}_{b}^{3} {n}_{b} {η}_{b}^{( j )} + {d}_{c}^{3} {n}_{c} {η}_{c}^{( j )} ) \qquad ( 13 )$$

To accurately determine the influence of fan speed on particle characterization, experiments are conducted across three distinct speeds. These experiments utilize a monodisperse aerosol generator, which produces particles of uniform size, enhancing the control and consistency of aerosol composition. This setup not only improves the characterization accuracy but also allows for precise manipulation of experimental variables.

For instance, consider the scenario of generating particles in size bin i at a given fan speed j as given by Equation (14). In this case,

$$\frac{1}{\sqrt{{ρ}_{p}}}$$

and dᵢ are known parameters, \dot{f} is the measured frequency change by the sensor, and nᵢ is determined using a particle size spectrometer. This setup enables the calculation of

$${η}_{i}^{( j )} ,$$

providing a direct measure of now fan speed impacts the efficiency of particle deposition for the specific size bin i.

$$\dot{f} = \frac{1}{\sqrt{{ρ}_{p}}} {d}_{i}^{3} {n}_{i} {η}_{i}^{( j )} \qquad ( 14 )$$

The same experimental setup and process are replicated for each size bin (a, b, c) across all target fan speeds (1, 2, and 3). This comprehensive characterization yields a matrix of efficiency factors

$${η}_{i}^{( j )}$$

for each size bin at each fan speed, summarized as follows:
For fan speed 1:

$${η}_{a}^{( 1 )} , {η}_{b}^{( 1 )} , {η}_{c}^{( 1 )}$$

For fan speed 2:

$${η}_{a}^{( 2 )} , {η}_{b}^{( 2 )} , {η}_{c}^{( 2 )}$$

For fan speed 3.

$${η}_{a}^{( 3 )} , {η}_{b}^{( 3 )} , {η}_{c}^{( 3 )}$$

### Phase II: User Setup

Setup Mode is a critical phase in the process where the sensor's responsiveness to various fan speeds is analyzed. This analysis is built in each sensor and adjusts the sensor's calibration based on the current ambient PM size distribution profile; a procedure initiated by end users whenever they suspect changes in the particulate environment. During this phase, the target values to be determined are

$$\frac{{n}_{i}}{{n}_{t o t}} .$$

Assuming all other values are knowns, Equation (12) would represent one equation and l unknowns. To be able to solve this equation, we need another l−1 equations. This is achieved in the presented algorithm by repeating the same for a number of fan speeds equal to the number of bins. Equation (12) now turns into a system of l independent equations, that could be solved to get all the information about the ambient particles. If the number of bins is large enough,

$$\frac{{n}_{i}}{{n}_{t o t}}$$

values can be used to precisely calculate PM values. However, to simplify and accelerate the process, we assume the particle follow a lognormal distribution, which is explained next.

### Example Calculation:

The particle size distribution is typically modeled using a lognormal function characterized by a mean (μ) and standard deviation (σ), parameters that describe the distribution in logarithmic space, see Equation (15).

Upon initiation of Setup Mode, the sensor cycles through three predefined fan speeds, labeled j. Each speed influences the particle deposition rate differently, reflecting in the frequency change Equation (16). The total particle number per unit volume, nₜₒₜ, is the sum of individual counts across all size bins is then given by Equation (17).

$${\int }_{0}^{x} f ( d , μ , σ ) dd = \sqrt{\frac{1}{2 π}} {\int }_{0}^{x} ( \frac{1}{d . σ} {e}^{- \frac{{( ln ( \sqrt{\frac{{ρ}_{w}}{{ρ}_{p}}} d ) - ln ( μ ) )}^{2}}{2 {( ln ( σ ) )}^{2}}} ) d ( d ) \qquad ( 15 )$$

$${\dot{f}}^{( j )} = \frac{1}{\sqrt{{ρ}_{p}}} ( {η}_{a}^{( j )} \cdot {n}_{a} \cdot {d}_{a}^{3} + {η}_{b}^{( j )} \cdot {n}_{b} \cdot {d}_{b}^{3} + {η}_{c}^{( j )} \cdot {n}_{c} \cdot {d}_{c}^{3} ) \qquad ( 16 )$$

$${n}_{tot} = {n}_{a} + {n}_{b} + {n}_{c} \qquad ( 17 )$$

By solving Equation (16) for all fan speeds, where

$${η}_{i}^{( j )}$$

are known from Phase 1, and Equation (17) the particle distribution ratios

$$( \frac{{n}_{a}}{{n}_{t o t}} , \frac{{n}_{b}}{{n}_{t o t}} , and \frac{{n}_{c}}{{n}_{t o t}}$$

for the example calculation) could be calculated. The determination of μ, σ, and ρₚ is achieved by solving integral equations that represent the cumulative distribution function (CDF) of the particle size distribution, which are given by Equations (18) to (20) respectively.

$${\int }_{0}^{a} f ( d , μ , σ ) dd = \frac{{n}_{a}}{{n}_{t o t}} \qquad ( 18 )$$

$${\int }_{0}^{b} f ( d , μ , σ ) dd = \frac{{n}_{a} + {n}_{b}}{{n}_{t o t}} \qquad ( 19 )$$

$${\int }_{0}^{c} f ( d , μ , σ ) dd = 1 \qquad ( 20 )$$

At this point, the lognormal distribution of the particles is updated using the calculated μ, σ, and βₚ values.

### Phase 3: Measurement

In the final measurement phase, the sensor operates at a designated fan speed, the total particle concentration is calculated. The frequency change for fan speed j is calculated as Equation (21). By solving this equation

$$\frac{{n}_{t o t}}{\sqrt{{ρ}_{p}}}$$

can be calculated. Next, we can use the size distribution from Phase 2 to find the PM values as given by Equation (22) where lₓ is the size bin corresponding to particles that are as large as x.

$$\dot{f} = \frac{{n}_{t o t}}{\sqrt{{ρ}_{p}}} {\sum }_{i = 0}^{i = l} ( {d}_{i}^{3} \frac{{n}_{i}}{{n}_{t o t}} {η}_{i}^{( j )} ) \qquad ( 21 )$$

$$P {M}_{x} = {n}_{tot} {\sum }_{i = 0}^{{l}_{x}} {ρ}_{p} {V}_{i} \frac{{n}_{i}}{{n}_{t o t}} \qquad ( 22 )$$

### Example Calculation:

For the three size bins a, b, c that we have studied so far, Equation (21) can be simplified to Equation (22). By solving this equation

$$\frac{{n}_{t o t}}{\sqrt{{ρ}_{p}}}$$

can be calculated. Next, we can use the lognormal distribution from Phase 2 to find the PM values as defined in Equation (23) where x is the aerodynamic size limit for the desired PM calculation, e.g. 2.5 μm for PM2.5.

$${\dot{f}}^{( j )} = \frac{{n}_{t o t}}{\sqrt{{ρ}_{p}}} ( {η}_{a}^{( j )} \cdot \frac{{n}_{a}}{{n}_{t o t}} \cdot {d}_{a}^{3} + {η}_{b}^{( j )} \cdot \frac{{n}_{b}}{{n}_{t o t}} \cdot {d}_{a}^{3} + {η}_{c}^{( j )} \cdot \frac{{n}_{c}}{{n}_{t o t}} \cdot {d}_{a}^{3} ) \qquad ( 23 )$$

$$P {M}_{x} = {\int }_{0}^{x} f ( d , μ , σ ) {ρ}_{p} V {n}_{tot} d d \qquad ( 24 )$$

Accordingly, this comprehensive calibration approach ensures the sensor remains finely tuned to environmental variations, enhancing its reliability and accuracy in real-world applications.

Accordingly, the inventors have demonstrated a piezoelectrically actuated resonating MEMS membrane as a detector of particulate matter in air. The tested device showed a clearly detectable shifts in the resonant frequency as the particles deposited on the MEMS resonator membrane. As described above this MEMS resonator may form part of a particulate matter sensing system consisting of a virtual impactor to direct the particle sizes of interest towards the sensor membrane in conjunction with an integrated heater used to remove particles from the resonator surface periodically to ensure long term reliability of the sensor. Accordingly, these MEMS resonators can be employed with highly-compact, low-cost, and accurate PDS devices etc. Such PDS can provide periodic or continuous monitoring against environmental regulations etc. such as the WHO PM limits on particulate exposure. Accordingly, the inventors believe that such PM sensors will allow for easy deployment of smart portable PDS devices for personal health monitoring etc.

Whilst the embodiments of the invention described and depicted with respect to FIGS. 1 to 13 have been described and depicted with respect to particulate/particle sensing within air it would be evident that the devices and methods described may be applied to particulate/particle sensing within other fluids including other gases or gas combinations as well as liquids. Whilst a MEMS resonator may suffer damping from a liquid, the shift in resonant frequency or electrical S-parameter may still be evident from the loading of particulates/particles deposited onto the membrane from the liquid.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of detecting particles comprising:
providing a sensor module comprising a microelectromechanical systems (MEMS) resonator and an electrode atop the MEMS resonator where the MEMS resonator is anchored by at least one anchor;
exposing the MEMS resonator to a flow of fluid comprising a plurality of particles; and
determining in dependence upon a shift in a characteristic of the MEMS resonator a mass of a portion of the particles deposited upon the MEMS resonator; wherein
the MEMS resonator is driven;
the flow of fluid is established by an output of a virtual impactor and a fan associated with the sensor module; and
the MEMS resonator includes a heater which is periodically actuated to clean another portion of the portion of the particles the particles deposited upon the MEMS resonator via thermophoresis to the fluid flowing past the MEMS resonator.

2. The method according to claim 1, wherein
the flow of fluid comprising the plurality of particles is established by the virtual impactor receiving another flow of fluid comprising another plurality of particles;
the plurality of particles comprises particles within the another plurality of particles having a maximum defined dimension.

3. The method according to claim 1, wherein
the flow of fluid comprising the plurality of particles is established by the virtual impactor receiving another flow of fluid comprising another plurality of particles;
the plurality of particles comprises particles within another plurality of particles having a maximum defined dimension; and
the flow of fluid is substantially perpendicular to another flow of fluid.

4. The method according to claim 1, wherein
the plurality of particles comprises particles within another plurality of particles having a maximum defined dimension; and
the maximum predetermined dimension is established in dependence upon the dimensions of a virtual impactor which establishes the flow of fluid comprising the plurality of particles from another flow of fluid comprising another plurality of particles and a flow rate of another flow of fluid.

5. The method according to claim 1, wherein
determining in dependence upon a shift in a characteristic of the MEMS resonator a mass of a portion of the particles deposited upon the membrane comprises:
executing a calibration process upon the sensor module to establish for each specific fan speed of a set of fan speeds an efficiency factor for the MEMS resonator by running the fan at each specific fan speed and injecting particles of a defined dimension into the sensor module and solving for a frequency dependent offset in the MEMS resonator; and
establishing the mass of the portion of particles during operation of the sensor module with the fan at a specific fan speed of the set of fan speeds in dependence upon a measured frequency dependent offset of the MEMS resonator and the efficiency factor for the MEMS resonator at the specific fan speed of the set of fan speeds.

6. The method according to claim 1, wherein
determining in dependence upon a shift in a characteristic of the MEMS resonator a mass of a portion of the particles deposited upon the membrane comprises:
executing a calibration process upon the sensor module to establish for each specific fan speed of a set of fan speeds an efficiency factor for the MEMS resonator by running the fan at each specific fan speed and injecting particles of a defined dimension into the sensor module and solving for a frequency dependent offset in the MEMS resonator;
executing a set-up process for the sensor module upon installation of the sensor module in a location for which a particle count of particles of the maximum defined size is required; and
establishing the mass of the portion of particles during operation of the sensor module with the fan at a specific fan speed of the set of fan speeds in dependence upon a measured frequency dependent offset of the MEMS resonator and the efficiency factor for the MEMS resonator at the specific fan speed of the set of fan speeds.

7. The method according to claim 1, wherein
the sensor module further comprises another MEMS resonator within the flow of fluid; and
either:
the another MEMS resonator is disposed at a different distance from a defined point within the virtual impactor to that of the MEMS resonator;
or:
the another MEMS resonator is disposed at a different distance from a defined point within the virtual impactor to that of the MEMS resonator.

8. The method according to claim 1, further comprising
determining in dependence upon a shift in a characteristic of another MEMS resonator a mass of a portion of other particles deposited upon the another MEMS resonator; wherein
the sensor module further comprises the another MEMS resonator which is exposed to another flow of fluid comprising a plurality of other particles where the another flow of fluid is an output of another virtual impactor coupled to another output of the virtual impactor;
the another MEMS resonator is driven and includes a heater which is periodically actuated to clean another portion of the portion of the other particles deposited upon the another MEMS resonator via thermophoresis to the another fluid flowing past the another MEMS resonator.

9. A method comprising:
executing a calibration process upon a sensor module to establish for each specific fan speed of a set of fan speeds an efficiency factor for a microelectromechanical systems (MEMS) resonator forming part of the sensor module by running a fan at each specific fan speed and injecting particles of a defined dimension into the sensor module and solving for a frequency dependent offset in the MEMS resonator; and
establishing the mass of the portion of particles during operation of the sensor module with the fan at a specific fan speed of the set of fan speeds in dependence upon a measured frequency dependent offset of the MEMS resonator and the efficiency factor for the MEMS resonator at the specific fan speed of the set of fan speeds.

10. The method according to claim 9, wherein
the sensor module comprises the MEMS resonator, an electrode atop the MEMS resonator where the MEMS resonator is anchored by at least one anchor, a virtual impactor and the fan;
the fan establishes a flow of fluid into the virtual compactor and the MEMS resonator is disposed within an output of the virtual impactor.
